(19) United States
(12) Patent Application Publication
(10) Pub. No.: US 2003/0147932 A1
(43) Pub. Date: Aug. 7, 2003

(54) Self-cleaning lotus effect surfaces having antimicrobial properties

(75) Inventors: Edwin Nun, Billerbeck (DE); Markus Oles, Hattingen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: CREAVIS Gesellschaft fuer Tech. und Innovation mbH, Marl (DE)

(21) Appl. No.: 10/214,202

(22) Filed: Aug. 8, 2002

(30) Foreign Application Priority Data
Aug. 10, 2001 (DE) 101 39 574.4

(51) Int. Cl. A01N 25/00

(52) U.S. Cl. 424/405

(57) ABSTRACT

A self-cleaning or lotus-effect surface that has antimicrobial properties, commercial products comprising such a surface, and uses thereof. A process for the production of an antimicrobial self-cleaning or lotus-effect surface in which one or more antimicrobial polymer(s) is secured to a surface-coating system for securing structure-formers to generate a self-cleaning surface. This method lastingly binds antimicrobial polymers to the self-cleaning surface. Commercial products comprising an antimicrobial self-cleaning or lotus-effect surface.

### CROSS-REFERENCE TO RELATED APPLICATIONS

This application claims priority to German Patent Application 101 39 574.4, filed Aug. 10, 2001, the entire contents of which are hereby incorporated by reference.

### BACKGROUND OF THE INVENTION

1. Field of the Invention

Antimicrobial self-cleaning (lotus effect) surfaces, especially surfaces comprising a mixture of hydrophobic and antimicrobial particles. These surfaces have a number of advantageous properties. For instance, unlike conventional self-cleaning surfaces, these surfaces resist microbial colonization or contamination and thus permit the self-cleaning properties of the surface to be maintained for a longer period of time. Moreover, the self-cleaning surface may comprise a contact-microbicidal polymer to eliminate or reduce adverse environmental effects of using conventional microbicides.

2. Description of the Related Art

Similar to the leaf surfaces of the lotus plant, lotus-effect surfaces are extremely difficult to wet and have self-cleaning properties. The water-repellant lotus effect is attributable to elevations of hydrophobic epicuticular wax which forms a rough or bumpy microstructure on the lotus leaf. The bumpy surface provides small contact areas which reduce the Van der Waals interaction, which is responsible for adhesion of water to flat surfaces with low surface energy. Water applied to a lotus-effect surface forms droplets having a very high contact angle.

The contact angle measures the tendency of a liquid to spread or wet a solid surface. A low contact angle indicates a greater tendency for the liquid to wet the surface. For instance, complete surface wetting occurs at a contact angle of zero degrees.

Adhesion of two components, such as adhesion of dust or dirt to a surface, is generally the result of surface-energy-related parameters representing the interaction of the two surfaces which are in contact. In general, the two contacted components attempt to reduce their free surface energy. Strong adhesion is characterized by a large reduction if free surface energy of two adhered surfaces. On the other hand, if the reduction in free surface energy between two components is intrinsically very low, it can generally be assumed that there will only be weak adhesion between these two components. Thus, the relative reduction in free surface energy characterizes the strength of adhesion. In pairings where one surface energy is high and one surface energy is low, the crucial factor is very often the opportunity for interactive effects. For example, when water is applied to a hydrophobic surface it is impossible to bring about any noticeable reduction in surface energy. Accordingly, surface wetting is poor. Similarly, perfluorinated hydrocarbons, e.g. polytetrafluoroethylene, have very low surface energy and few components, such as water, adhere to surfaces of this type.

Accordingly, on such a low surface energy surface, the affinity of water molecules for each other much more energetically favored than binding of a water molecule to the lotus-effect surface. Thus, water forms droplets which roll off the leaf. On the other hand, these droplets do stick to particulate contaminants on the lotus-effect surface, and carry them away as they rolls off the leaf surface. Thus, providing a self-cleaning effect.

Similarly, this principle has been borrowed from the natural world to design artificial surfaces having lotus-effect properties. These surfaces confer a number of commercially significant features to articles or products comprising them, such as reduced maintenance costs due to their self-cleaning properties and such self-cleaning surfaces are of great commercial interest.

Production of hydrophobic surfaces using hydrophobic materials, such as perfluorinated polymers, is known. A further development of these surfaces consists in structuring the surfaces in the μm to nm range. U.S. Pat. No. 5,599,489 discloses a process in which a surface can be roughened by bombardment with particles of an appropriate size, and can be rendered particularly repellent by subsequent perfluorination. Another process is described by H. Saito et al. in “Surface Coatings International” 4, 1997, pp. 168 et seq. Here, particles made from fluoropolymers are applied to metal surfaces, whereupon a marked reduction was observed in the wettability of the resultant surfaces with respect to water, with a considerable reduction in tendency toward icing.

U.S. Pat. No. 3,354,022 and WO 96/04123 describe other processes for reducing the wetability of articles via topological alterations in the surfaces. Here, artificial elevations or depressions with a height of from about 5 to 1,000 μm and with a separation of from about 5 to 500 μm are applied to materials which are hydrophobic or are hydrophobicized after the structuring procedure. Surfaces of this type lead to rapid droplet formation, and as the droplets roll off they absorb dirt particles and thus clean the surface.

WO 00/58410 describes self-cleaning structures and claims the formation of the same by spray-application of hydrophobic alcohols, such as 10-nonacosanol, or of alkanediols, such as 5,10-nonacosandiol. A disadvantage here is that the self-cleaning surfaces lack mechanical stability, since detergents remove the structure and self-cleaning properties.

Another method of producing easy-clean surfaces has been described in DE 19917367 A1. However, coatings based on fluorine-containing condensates are not self-cleaning. Although there is a reduction in the area of contact between water and the surface, this is insufficient.

EP 1 040 874 A2 describes the embossing of micro-structures and claims the use of structures of this type in analysis (microfluidics). A disadvantage of these structures is their unsatisfactory mechanical stability.

Polymers that have anti-microbial properties are disclosed by the following patent applications: DE 10024270, DE 10022406, PCT/EP 00/06501, DE 10014726, and DE 10008177. There are no low-molecular-weight constituents present in these polymers. The antimicrobial properties are attributable to the contact of bacteria with the surface. European patent application EP 0 862 858 discloses that copolymers of tert-butylaminoethyl methacrylate, a methacrylate with a secondary amino function (Amina T-100 copolymer) have microbicidal properties.

Although some of the above-mentioned surfaces may have excellent self-cleaning properties, the attachment or colonization of microorganisms can impair these properties. For instance, bacteria may colonize a self-cleaning surface of a pipeline, container, or a packaging material, particularly if the topography of the self-cleaning surface permits the accumulation of water. Such microbial contamination is highly undesirable, since it impairs, or may entirely remove, the self-cleaning properties of the surface. Moreover, the formation of a slime layer on such a surface permits a sharp rise in microbial populations, which can lead to subsequent impairment of the quality of water or of drinks or foods, and even to spoilage of the product in contact with a contaminated surface, and thus increase the risk or harm to consumer health and well-being.

Accordingly, bacteria and other microbes must be kept away from all fields of life where hygiene is important. This applies to various industrial or commercial products, including furniture and surfaces of equipment, separators for privacy protection, and to walls and partitions in the sanitary sector.

Although certain building material surfaces may be water-repellent, algal growth may occur on the exterior of buildings equipped with plastic surfaces of this type. In addition to undesirable appearance, there can sometimes also be a reduction in the function of the components concerned. An example, which may be mentioned in this context, is algal infestation of surfaces with a photovoltaic function. As algal growth increases, the self-cleaning effect of such surfaces is lost.

Another form of microbial contamination for which again no technically-satisfactory solution has yet been found is fungal infestation of surfaces. For example, Aspergillus niger infestation of joints or walls in wet areas within buildings not only impairs appearance but also has serious health implications, since many people are allergic to the antigens of, or substances given off by the fungi. Thus, exposure to such microorganisms may result in disorders, such as serious chronic respiratory disease.

While chemical treatment or disinfectants may be used to reduce microbial contamination of surfaces, including self-cleaning surfaces, such chemicals have numerous undesirable effects, such as toxicity to humans or animals or to the environment. Such undesirable effects may be particularly pronounced for chemicals or disinfectants that exert a fairly broad biocidal or antimicrobial action. Such chemical agents act nonspecifically and are themselves frequently toxic or act as irritants. For instance, they may adversely effect chemically sensitive people or induce chemical sensitivity or immunological or allergic intolerance in certain individuals. Moreover such chemicals or agents may form degradation products which are hazardous to health or to the environment.

Accordingly, there is a pronounced need for self-cleaning, lotus-effect structures that resist degradation or contamination by microorganisms and/or provide commercial and environmental benefits of avoiding the use of nonspecific chemical agents or disinfectants.

### BRIEF DESCRIPTIONS OF THE INVENTION

One object of the present invention, therefore, is to provide a self-cleaning lotus-effect surface whose self-cleaning action is not lost due to attachment of microorganisms, such as bacteria, algae, or fungi, and to provide a process for its production. Surprisingly, it has been found that the growth of such microorganisms on a hydrophobic self-cleaning surface composed of a carrier material and of a particulate system, the structure-forming material having antimicrobial properties and hydrophobic properties, is markedly slower than on conventional self-cleaning surfaces.

The present invention provides a surface with an artificial surface structure made from elevations and/or depressions that has self-cleaning properties, wherein the surface structure comprises materials with antimicrobial properties.

Another object of the invention is to provide a process for producing anti-microbial self-cleaning surfaces. Such a process comprises using, during the production of the surface structures, at least one material that has antimicrobial properties.

### BRIEF DESCRIPTION OF THE DRAWINGS

FIGS. 1, 2 and 3 show graphs of the results of the tests in examples 1 and 2 and those of the comparative example. WSH here means water of standardized hardness, and 2×2 indicates the test specimen size in cm.

FIG. 1 shows the results from the test in the comparative example produced without addition of anti-microbial powder. It can easily be seen that there is no presence of any kind of factor adversely affecting microbial growth.

FIG. 2 shows the results from the test of example 1. It can easily be seen that even 1% of antimicrobial powder admixture in the particle mixture brings about antimicrobial action.

FIG. 3 shows the results from the test of example 2. It can easily be seen that 10% of Amina T100 results in further improvement of antimicrobial properties.

### DETAILED DESCRIPTION OF THE INVENTION

The present invention provides a surface which has an artificial surface structure made from plurality of irregularities, such as elevations and/or depressions, that has self-cleaning properties. The surface structure comprises at least one material that has antimicrobial properties.

The terms antimicrobial and microbicidal may be both used to describe properties, such as the inhibition or prevention of microbial growth, attachment or adhesion, or the provision of a static (e.g. bacteriostatic) or cidal (e.g. bacteriocidal or fungicidal) activity. Such antimicrobial or microbicidal activities may be generally inhibitory or cidal for microorganisms, or may exhibit selective toxicity for particular classes or types of microorganisms.

The surfaces of the invention have the advantage of markedly slowing the attachment and spread of biological contamination, e.g. bacteria, fungi, and algae, and thus effectively retain their self-cleaning properties for a longer period.

Particular types of self-cleaning surfaces and materials used to produce such surfaces are described in the Examples below. However, there is no intention that the invention be restricted to these examples.

To achieve the self-cleaning action, it is advantageous for the separation of the hydrophobic elevations of the surface structure to be from 50 nm to 200 μm, preferably from 500 nm to 100 μm, and very particularly preferably from 0.1 to 20 μm. It is also advantageous for the height of the elevations of the surface structure to be from 50 to 100,000 nm, preferably from 50 to 50,000 nm and very particularly preferably from 100 to 30,000 nm.

In one particularly preferred embodiment of the surface of the invention, the surface has particles applied to form the elevations and depressions. The particles have preferably been secured to the surface by means of a carrier system. The particles may be a mixture of hydrophobic particles and particles with antimicrobial properties. It is very particularly preferable for the surface to have a mixture of hydrophobic particles and particles with antimicrobial properties, the content of particles with antimicrobial properties in the mixture being from 0.01 to 25% by weight, preferably from 0.01 to 20% by weight, and very particularly preferably from 1 to 15% by weight, based on the particle mixture.

It is preferable to use hydrophobic or hydrophobicized particles which have a particle diameter of from 0.02 to 100 μm, particularly preferably from 0.2 to 50 μm, and very particularly preferably from 0.3 to 30 μm. The separations of the individual particles on the surface of the surface structures of the invention are from 0 to 10 particle diameters, in particular from 0 to 3 particle diameters. The antimicrobial hydrophilic particles may preferably have particle diameters of from 1 to 3,000 μm, preferably from 20 to 2,000 μm, and very particularly preferably from 50 to 500 μm.

The particles may also be present in the form of aggregates or agglomerates, where, according to DIN 53 206, aggregates have (primary) particles in edge- or surface-contact, while agglomerates have (primary) particles in point-contact. The particles used may also be those formed by combining primary particles to give agglomerates or aggregates with a size of from 0.2 to 100 μm.

It can be advantageous for the hydrophobic or hydrophobicized particles used to have a structured surface. The surface of the particles used here preferably has an irregular fine nanostructure. The fine structure of the particles is preferably a fissured structure with elevations and/or depressions in the nanometer range. The average height of the elevations is preferably from 20 to 500 nm, particularly preferably from 50 to 200 nm. The separation between the elevations and, respectively, depressions on the particles is preferably less than 500 nm, very particularly preferably less than 200 nm. The effectiveness of the structure of the particles is promoted by these depressions, e.g. craters, clefts, notches, fissures, apertures, and cavities.

The hydrophobic particles used may be particles which have at least one material selected from the group consisting of silicates, doped or fumed silicates, minerals, metal oxides, silicas, metals, and polymers. The particles used, in particular those used as hydrophobic particles, and whose surface has an irregular fine nanostructure, are preferably particles which have at least one compound selected from the group consisting of fumed silica, aluminum oxide, silicon oxide, mixed oxides, fumed silicates, and pulverulent polymers, and pulverulent metals. It can be advantageous for the surface of the invention to have particles, which have hydrophobic properties. The hydrophobic properties of the particles may be inherently present by virtue of the material used for the particles. However, it is also possible to use hydrophobicized particles whose hydrophobic properties are the result of, for example, treatment with at least one compound selected from the group consisting of the alkylsilanes, perfluoroalkylsilanes, paraffins, waxes, fatty esters, functionalized long-chain alkane derivatives, and alkyldisilazanes.

The particles used that have antimicrobial properties, and generally have hydrophilic properties, are preferably those which have homo- or copolymers selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

Preferably, such surfaces comprise a contact-microbicidal polymer, copolymer or a mixture thereof. Advantageously, low-molecular weight constituents need not be added to such contact-microbicidal polymers or copolymers in order to obtain an antimicrobial effect. Such antimicrobial properties are attributable to the contact of bacteria with the surface.

The surface of the invention may be at least one area, such as a molding, made from a material selected from the class consisting of polymers, e.g. the polyamides, polyurethanes, polyether block amides, polyesteramides, polyvinyl chloride, polyolefins, polysilicones, polysiloxanes, polymethyl methacrylates, or polyterephthalates, and metals, wood, leather, fibers, fabrics, glass, and ceramics. The polymeric materials listed are merely examples. The invention is not restricted to those listed. If the molding is a molding made from polymers, it can be advantageous for this molding, and therefore the surface, to have a polymer with antimicrobial properties.

The surfaces of the invention are preferably produced using a process of the invention for producing surfaces with an artificial surface structure and having self-cleaning properties, which comprises using, during production of the surface structures, at least one material which has antimicrobial properties.

The surface structure, which has elevations or depressions, may be generated on the surface itself. An example of a method for this is to apply and secure particles on the surface to generate the surface structure. The application and securing of the particles on the surface may take place in a manner known to the skilled worker. An example of a chemical method of securing is the use of a carrier system. Carrier systems, which may be used, are various adhesives, adhesion promoters, or surface coatings. Other carrier systems or chemical fixing methods will be apparent to the skilled worker.

The material, which has antimicrobial properties, may be present either in the surface or else in the carrier system or in the particle system. At least some of the particles used preferably have a material, which has antimicrobial properties. The antimicrobial material used is preferably a homo- or copolymer prepared from 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, or 3-aminopropyl vinyl ether.

Very particular preference is given to the application to the surface of a particle mixture, which has particles with antimicrobial properties. It can be advantageous for the particle mixture to have a mixture of structure-forming particles and particles with antimicrobial properties, the content of particles with antimicrobial properties in the mixture, based on the particle mixture, being from 0.01 to 25% by weight, preferably from 0.1 to 20% by weight, and very particularly preferably from 1 to 15% by weight. The particles with antimicrobial properties may, of course, also contribute to formation of the structure. The particle mixture has to be balanced in such a way as to generate the antimicrobial action but retain the dominance of the hydrophobic properties needed for self-cleaning.

One example of a way of applying the particle mixture to the surface to generate the surface structure and the antimicrobial properties is one in which the carrier system, which may be a curable substance, is applied to the surface using a spray, a doctor, a spreader, or a jet. The thickness applied of the curable substance is preferably from 1 to 200 μm, with preference from 5 to 75 μm. Depending on the viscosity of the curable substance, it can be advantageous to permit the substance to begin curing before the particles are applied. The selection of the viscosity of the curable substance ideally permits the particles applied to sink at least to some extent into the curable substance, but ideally prevent uncontrolled flow of the curable substance or the particles applied thereto when the surface is placed vertically.

One way of applying the particles themselves is the use of a spray. In particular, the particles may be applied by using a spray from an electrostatic spray gun. Once the particles have been applied, excess particles, i.e. particles not adhering to the curable substance, may be removed from the surface by shaking, brushing, or blowing. These particles may be collected and reused.

In this embodiment of the process of the invention, the particles are secured to the surface via curing of the carrier system, which preferably takes place by virtue of the energy present in heat and/or in light. It is particularly preferable for the carrier system to be cured by the energy present in light. The curing of the carrier preferably takes place under an atmosphere of inert gas, very particularly preferably under an atmosphere of nitrogen.

Particular carrier systems which may be used are UV-curing, hot-curing, or air-curing coating systems. Coating systems include mixtures of surface-coating type made from monounsaturated acrylates or methacrylates with polyunsaturated acrylates or methacrylates, and also mixtures of polyunsaturated acrylates and, respectively, methacrylates with one another. Coating systems also include urethane-based surface coating systems. The mixing ratios may be varied within wide limits. Depending on the structure-forming component to be added subsequently, it is possible to add other functional groups, such as hydroxyl groups, ethoxy groups, or amines, ketones, isocyanates, or the like, or else fluorine-containing monomers, or inert filler components, such as polymers soluble in a monomer mixture. The additional functionality serves primarily for more effective attachment of the structure-formers. Other carrier systems, which may used are straight acrylate dispersions and powder paint systems. It can be advantageous if the carrier system also has a material, which has antimicrobial properties.

The structuring particles used may be hydrophobic or hydrophobicized particles which have at least one material selected from the group consisting of silicates, doped or fumed silicates, minerals, metal oxides, silicas, metals, and polymers. It is particularly preferable to make concomitant use of particles which have a particle diameter of from 0.02 to 100 μm, particularly from 0.1 to 50 μm, and very particularly from 0.3 to 30 μm.

The particles preferably have hydrophobic properties in order to generate the self-cleaning surfaces. The particles may themselves be hydrophobic, e.g. particles comprising PTFE, or the particles used may have been hydrophobicized. The particles may be hydrophobicized in a manner known to the skilled worker, e.g. by treatment with at least one compound selected from the group consisting of the alkylsilanes, perfluoroalkylsilanes, paraffins, waxes, fatty esters, functionalized long-chain alkane derivatives, and alkyldisilazanes. Examples of typical hydrophobicized particles are very fine powders, such as Aerosil R 974 or Aerosil R 8200 (Degussa AG), which are available for purchase.

The hydrophobic particles used preferably have at least one material selected from the group consisting of silicates, doped silicates, minerals, metal oxides, mixed metal oxides, fumed silicas, precipitated silicas, and polymers. The particles very particularly preferably have silicates, fumed silicas, or precipitated silicas, in particular Aerosils, minerals, such as magadiite, Al₂O₃, SiO₂, TiO₂, ZrO₂, or Zn powder coated with Aerosil R 974, or pulverulent polymers, e.g. cryogenically milled or spray-dried polytetrafluoroethylene (PTFE).

Particular preference is given to the use of hydrophobic particles with BET surface area of from 50 to 600 m²/g. Very particular preference is given to the use of particles whose BET surface area is from 50 to 200 m²/g.

The particles used and having antimicrobial properties may be particles which have homopolymers or copolymers prepared from 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, or 3-aminopropyl vinyl ether. The particles may consist entirely of the material having antimicrobial properties, or have the antimicrobial material as a coating. Particular preference is given to the use of particles having antimicrobial properties and a particle diameter of from 1 to 3,000 μm, particularly from 20 to 2,000 μm, and very particularly from 50 to 500 μm.

Generally, the antimicrobial particles must not be hydrophobicized, since the antimicrobial property is lost when a hydrophobicizing reagent covers the surface.

The particles may also be present in the form of aggregates or agglomerates, where, according to DIN 53 206, aggregates have (primary) particles in edge- or surface-contact, while agglomerates have (primary) particles in point-contact. The particles used may also be those formed by combining primary particles to give agglomerates or aggregates with a size of from 0.2 to 100 μm.

It can be advantageous for the particles used to have a structured surface. The surface of the particles used here preferably has an irregular fine nanostructure. The fine structure of the particles is preferably a fissured structure with elevations and/or depressions in the nanometer range. The average height of the elevations is preferably from 20 to 500 nm, particularly preferably from 50 to 200 nm. The separation between the elevations and, respectively, depressions on the particles is preferably less than 500 nm, very particularly preferably less than 200 nm. The effectiveness of the structure of the particles is promoted by these depressions, e.g. craters, clefts, notches, fissures, apertures, and cavities.

The process of the invention may be used with excellent results for producing self-cleaning surfaces on planar or non-planar articles, in particular on non-planar articles, which retain their antimicrobial properties after damage. This is possible only to a limited extent using conventional processes. In particular, processes in which prefabricated films are applied to a surface are not usable, or usable only to a limited extent, on non-planar articles, e.g. sculptures. The process of the invention, however, may of course also be used to produce self-cleaning surfaces on articles with planar surfaces, e.g. greenhouses or public conveyances. The use of the process of the invention for producing self-cleaning surfaces on greenhouses has particular advantages, since the process can also produce self-cleaning surfaces on transparent materials, for example, such as glass or Plexiglas®, and the self-cleaning surface can be made transparent at least to the extent that the amount of sunlight which can penetrate the transparent surface equipped with a self-cleaning surface is sufficient for the growth of the plants in the greenhouse. Greenhouses which have a surface of the invention as claimed in any of claims 1 to 8 can be operated with intervals between cleaning which are longer than for conventional greenhouses, which have to be cleaned regularly to remove leaves, dust, lime, and biological material, e.g. algae.

The present invention also provides the use of the self-cleaning antimicrobial surfaces produced according to the invention. Products of this type are preferably based on substrates such as polymers, e.g. on polyamides, on polyurethanes, on polyether block amides, on polyester amides, on polyvinyl chloride, on polyolefins, on polysilicones, on polysiloxanes, on polymethyl methacrylates, or on polyterephthalates, or else on metals, on wood, on leather, on fibers, on fabrics, on glass, or on ceramics, these having surfaces coated using inventive compounds and, respectively, polymer formulations and structure-formers. The polymeric materials listed are merely examples. The invention is not restricted merely to those mentioned.

Examples of products of this type having antimicrobial self-cleaning layers are in particular components of air conditioning systems, coated pipes, semi-finished products, roofing, bathrooms, toilet items, kitchen items, components of sanitary equipment, components of animal cages or of animal houses, and materials used in what may be called textile buildings.

The self-cleaning coatings with antimicrobial properties may be used wherever the absence of microbes is required or desirable. For instance, on surfaces, to be kept as free as possible from bacteria, algae, and fungi, e.g. microbicidal surfaces, or surfaces with release properties. Examples of the use of the surfaces of the invention are found in the following sectors:

| | |
|---|---|
| marine: | aquatic structures, equipment and supplies, |
| | including docks, pylons, piers, buoys, |
| | drilling platforms. |
| materials: | building materials including roofing, |
| | siding, soffit and rake materials, |
| | flooring, windows and window frames, |
| | surface coatings or texturing compounds, |
| | wood protection coatings or compounds. |
| structures: | walls, facades, greenhouses, solariums, |
| | skylights, sun protection, garden fences, |
| | awnings, blinds, tents, textile buildings. |
| sanitary: | public sanitary installations, including, |
| | toilets, sinks, showers, bathtubs, bathroom |
| | surfaces, shower curtains, toilet items, |
| | saunas, swimming pools, hospital equipment, |
| | equipment in medical practices and in |
| | physiotherapeutic treatment centers |
| food and drink: | kitchens and kitchen surfaces, kitchen |
| | fixtures, equipment or supplies. Food |
| | handling equipment or supplies. |
| machine parts: | bioreactors, solar installations, |
| | photovoltaic systems |
| transportation: | public conveyances, vehicles, trucks, |
| | automobiles, boats. |
| Other: | sheathing, such as electrical sheathing or |
| | shielding, truck tarpaulins, animal cages, |
| | conduits, pipes, utility fixtures, such as |
| | telephone poles. |

The examples below are intended to provide further illustration of the surfaces of the invention, but there is no intention that the invention be restricted to these embodiments.

### COMPARATIVE EXAMPLE

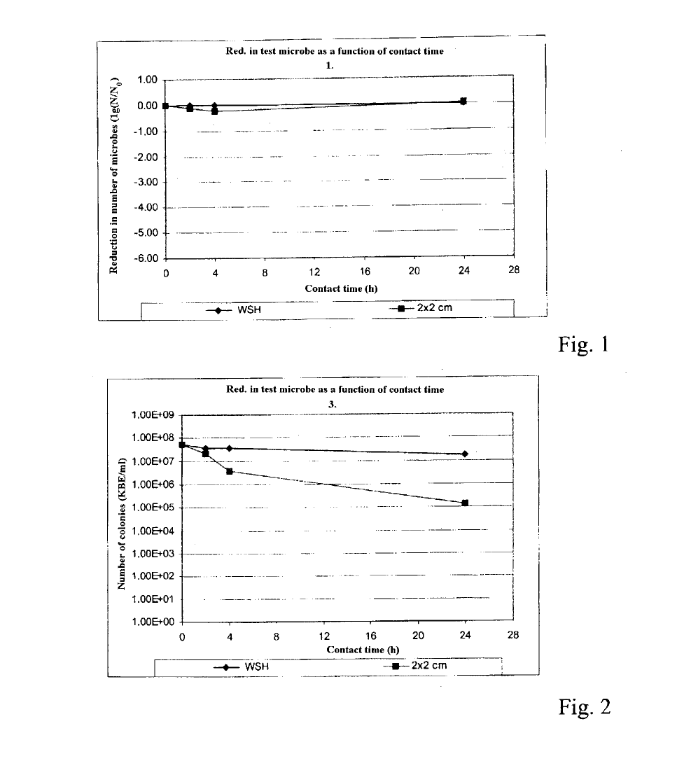

20% of methyl methacrylate, 20% of pentaerythritol tetraacrylate, and 60% of hexanediol dimethacrylate are mixed together. Based on this mixture, 14% of Plex 4092 F (Röhm) and 2% of Darocur 1173 (UV hardener) are added and the mixture is stirred for at least 60 min. This mixture is applied at a thickness of 50 μm to a PMMA sheet of thickness 2 mm, and 5 min are allowed for the layer to begin drying. A silica (Aerosil R8200, Degussa AG) is then applied by scattering, and 3 min later a wavelength of 308 nm is used for curing, under nitrogen. Excess Aerosil R8200 is removed by brushing. The surfaces are characterized visually and recorded as +++, meaning that there is virtually complete formation of water droplets and the roll-off angle is less than 10°. Assessment of microbicidal action with respect to the test microbe Staphylococcus aureus at 30° C. in water of standardized hardness demonstrated that there is no reduction in the number of microbes, where in FIG. 1 N is the number of microbes counted per unit of volume, and N₀ is the number of microbes determined at the corresponding time in water of standardized hardness.

### Example 1

20% of methyl methacrylate, 20% of pentaerythritol tetraacrylate, and 60% of hexanediol dimethacrylate are mixed together. Based on this mixture, 2% of Darocur 1173 (UV hardener) and 14% of Amina T100 are admixed. The mixture is stirred for at least 60 min, applied at 50 μm thickness to a PMMA sheet of thickness 2 mm, and permitted to begin drying for 5 min. A mixture made from 99% of Aerosil R8200 with 1% of Amina T100 is then applied electrostatically, and 3 min later a wavelength of 308 nm is used for curing, under nitrogen. Excess particle mixture is removed by brushing. The surface is characterized visually and recorded as +++, meaning that there is virtually complete formation of water droplets and the roll-off angle is less than 10°. Assessment of microbicidal activity with respect to the test microbe Staphylococcus aureus at 30° C. in water of standardized hardness gives a logarithmic factor of 2.08. This is calculated by subtracting the logarithmic CFU (colony-forming units) values given on the graph.

### Example 2

Using a method based on example 1, the monomers are mixed and the coating procedure carried out. The particles were mixed from 90% of Aerosil R8200 with 10% of Amina T100 and applied electrostatically. The surfaces were characterized visually and recorded as +++. Assessment of microbicidal activity with respect to the test microbe Staphylococcus aureus at 30° C. in water of standardized hardness gives a logarithmic factor of 3.47. This is calculated by subtracting the logarithmic CFU (colony-forming units) values given on the graph.

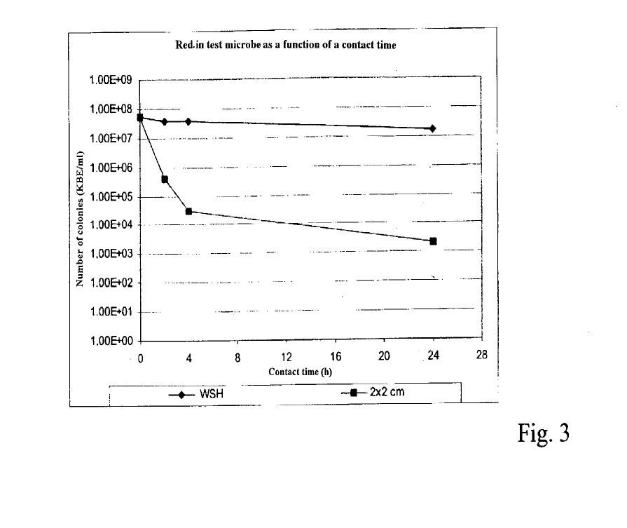

The graphs shown in FIGS. 2 and 3 relate to testing of the antimicrobial action of self-cleaning surfaces. These show that a marked reduction in colony-forming units is found on the surfaces produced according to the invention as in examples 1 and 2. The self-cleaning surface of the comparative example has no antimicrobial properties and shows no reduction of the numbers of microbes when compared with the comparative medium (FIG. 1).

Modifications and Other Embodiments

Various modifications and variations of the invention as well as compositions and methods of using such surfaces and the concept of the invention will be apparent to those skilled in the art without departing from the scope and spirit of the invention. Although the invention has been described in connection with specific preferred embodiments, it should be understood that the invention as claimed is not intended to be limited to such specific embodiments. Various modifications of the described modes for carrying out the invention which are obvious to those skilled in the chemical, chemical engineering, materials science, safety, health, microbiological, medical, engineering, construction, manufacturing and related fields are intended to be within the scope of the following claims.

Incorporation by Reference

Each document, patent application or patent publication cited by or referred to in this disclosure is incorporated by reference in its entirety. Any patent document to which this application claims priority is also incorporated by reference in its entirety. Specifically, German Patent Application 101 39 574.4, dated Aug. 10, 2001 is hereby incorporated by reference.

What is claimed is:

1. A lotus-effect surface comprising a substrate having a surface and a plurality of irregularities associated with said surface, wherein said lotus-effect surface comprises at least one anti-microbial material.

2. The lotus-effect surface of claim 1, wherein said irregularities are particles.

3. The surface of claim that comprises particles having an irregular fine nanostructure.

4. The lotus-effect surface of claim 1, wherein said irregularities comprise a mixture of one or more types of hydrophobic particles and one or more types of anti-microbial particles.

5. The lotus-effect surface of claim 4, comprising a particle mixture that is about 0.01 to 25% by weight particles with antimicrobial properties.

6. The lotus-effect surface of claim 1 that comprises particles attached to the substrate by means of a carrier system.

7. The lotus-effect surface of claim 6, wherein the carrier system comprises a chemical fixative, adhesive, adhesion promoter, surface coating or curable substance.

8. The lotus-effect surface of claim 6 that comprises a coating that is UV curable, hot-curing or air curing.

9. The lotus-effect surface of claim 1, comprising at least one substrate material or molding selected from the group consisting of one or more polymer(s), metal(s), wood(s), leather(s), fiber(s), fabric(s), glass(es), and ceramic(s).

10. The lotus-effect surface of claim 1 that comprises at least one substrate material or molding selected from the group consisting of a polyamide, polyurethane, polyether block amide, polyesteramide, polyvinyl chloride, polyolefin, polysilicone, polysiloxane, polymethyl methacrylate, and polyterephthalate.

11. The lotus-effect surface of claim 1 comprising at least one antimicrobial polymer that may be prepared from at least one monomer selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

12. A process for producing the lotus-effect surface of claim 1 comprising producing a surface structure with at least one material having an antimicrobial property.

13. The process as claimed in claim 12 comprising producing a surface that has elevations, depressions, or both.

14. The process as claimed in claim 12 comprising producing the surface structure by applying particles to a substrate and securing them thereon.

15. The process of claim 14 comprising applying one or more hydrophobic particle(s), one or more antimicrobial particle(s), or both.

16. The process of claim 14, wherein the particles, are secured to the substrate using a carrier system.

17. The process of claim 16, wherein said carrier system comprises the use of chemical fixation or a coating system.

18. The process of claim 16, wherein the carrier system comprises use of an adhesive, surface coating, adhesion promoter, or curable substance.

19. The process of claim 14, wherein the substrate, the particles, and/or the carrier system comprises an antimicrobial material.

20. The process of claim 19, wherein the antimicrobial material comprises a polymer which has been prepared from at least one monomer selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

21. The process of claim 1, wherein the particles comprise least one material selected from the group consisting of a silicate, doped silicate, mineral, metal oxide, silica, and polymer, mixed with homo- or copolymer particles selected from the group consisting of 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-3-dimethylaminopropylacrylamide, 2-methacryloyloxyethyltrimethylammonium methosulfate, 2-methacryloyloxyethyltrimethylammonium chloride, 3-methacryloylaminopropyltrimethylammonium chloride, 2-acryloyloxyethyl-4-benzoyldimethylammonium bromide, 2-methacryloyloxyethyl-4-benzoyldimethylammonium bromide, 2-acrylamido-2-methyl-1-propanesulfonic acid, 2-diethylaminoethyl vinyl ether, and 3-aminopropyl vinyl ether.

22. The process of claim 14 comprising applying to a substrate hydrophobic particles that have an average particle diameter ranging from about 0.05 to about 30 μm.

23. The process of claim 14 comprising applying to a substrate particles with antimicrobial properties that have a diameter ranging from about 20 to about 2,000 μm.

24. The process of claim 14 comprising applying to a substrate particles having an irregular fine nanostructure.

25. A composition of matter comprising the lotus effect surface of claim 1.

26. A commercial or industrial material comprising the lotus-effect surface of claim 1.

27. A structure or building comprising the lotus effect surface of claim 1.

28. An aquatic or marine structure, fixture, equipment, or supply comprising the lotus effect surface of claim 1.

29. Plumbing equipment, fixtures, or supplies comprising the lotus effect surface of claim 1.

30. A sink, shower, bathtub, hot tub, sauna, swimming pool, toilet or bidet comprising the lotus effect surface of claim 1.

31. A vehicle or public conveyance comprising the lotus effect surface of claim 1.

32. Medical or hospital fixtures, equipment or supplies comprising the lotus effect surface of claim 1.

33. A food handling fixture, surface, utensil or equipment comprising the lotus effect surface of claim 1.

34. A textile, awning or blind, sun protection screen, shower curtain, or tarpaulin comprising the lotus effect surface of claim 1.

35. A solar installation, greenhouse, photovoltaic cell or bioreactor comprising the lotus effect surface of claim 1.
